(19) United States
(12) Patent Application Publication
(10) Pub. No.: US 2012/0212491 A1
(43) Pub. Date: Aug. 23, 2012

(54) INDIRECT LIGHTING PROCESS FOR VIRTUAL ENVIRONMENTS

(75) Inventor: Patrick T. Hager, San Diego, CA (US)

(73) Assignee: Sony Computer Entertainment Inc., Tokyo (JP)

(21) Appl. No.: 13/032,026

(22) Filed: Feb. 22, 2011

(51) Int. Cl. G06T 15/50

(52) U.S. Cl. 345/426

(57) ABSTRACT

Methods, systems, devices, and software are described for indirect lighting objects in 3-D virtual environments, such as in video games. A cube map and ground plane of the environment are translated to a 360-degree latitude-longitude map depicting a view from the position of an object. The lat-long map is blurred using a cosine convolution, and then the blurred lat-long map is converted to a local cube map for the object. The local cube map is then used to determine normal and reflective indirect lighting color on the object cast from the environment.

### CROSS-REFERENCES TO RELATED APPLICATIONS

NOT APPLICABLE

### BACKGROUND

1. Field of the Art

Generally, the present application relates to computer graphics processing for three-dimensional (3-D) environments, including lighting and shading of 3-D objects within 3-D environments. Specifically, methods, systems, and devices suitable for real-time rendering of indirect light and shade on objects in realistic video games are presented.

2. Description of the Related Art

Video games have become more immersive over the years. They often incorporate three-dimensional environments within which players explore, fight, and play. Such 3-D environments allow one to look in directions of his or her own choosing, seeing and manipulating objects in three dimensions.

3-D environments are also used in television, movies, and other pre-recorded formats as well. Such pre-recorded media can tell a story, illustrate a documentary, or educate a viewer. Other uses for 3-D environments include computer aided design (CAD) and computer aided manufacturing (CAM) to visualize workpieces, spaces, and layouts. In general, 3-D environments are often useful in real-time interactive and pre-recorded non-interactive formats.

For the latest video games, consumers often demand and expect realistic-looking 3-D virtual environments. The realism and intricacies of the virtual environments not only allow for beautifully stunning images that appeal to the eye for marketing purposes, but they also add to game play. Subtle visual cues, such as hues of the sky mixing and reflecting with dappled colors of an avatar's face, allow a player to judge expressions and catch emotions without studying a manual. These cues, derived from the natural world, are intuitive. Furthermore, barely-perceptible indirect lighting cues can help warn of danger from behind or overhead. Even when faced with danger in a world with which one has no previous experience, a user may unconsciously calibrate himself using indirect lighting to assess and react to the situation.

Although there have been great improvements in processing power and 3-D algorithms over the years, delivery of realistic looking 3-D images can be a difficult process. For pre-recorded media such as films and television, 3-D environments do not need to be rendered in real-time. They can be rendered in production, far before they are shown to the public. However, for video games in which viewers choose where they want to look and what they manipulate, 3-D environments often require real-time rendering. It is sometimes said that video games are like movies but rendered frame-by-frame in real-time.

High-end methods that deliver realistic 3-D, such as ray tracing, take so much processing power that with today's consumer technology they cannot reasonably be used for real-time rendering of fast action video games. Lower-end rendering methods, which use approximations and visual tricks, trade processing power for quality and realism. Yet, even lower-end rendering methods sometimes struggle to render 3-D environments at frame rates associated with contemporary gaming systems. For example, a frame rate of sixty frames per second (fps) is often a standard for smooth game play in contemporary video game systems. If a game designer is not careful in algorithm design, “popping,” or the discontinuous jumping of rendered objects, can occur. This may be especially apparent when many 3-D objects are being rendered at once in a complicated scene.

Rendering for stereoscopic 3-D displays essentially doubles the frame rate requirement. A scene must be rendered twice, once for the right eye and once for the left eye. One-hundred and twenty hertz is a common frequency for 3-D displays so that each eye view can be rendered at sixty frames per second.

There exists a need in the art for better, faster algorithms for rendering 3-D environments in video games and pre-recorded formats.

### BRIEF SUMMARY

Generally, methods, systems, and devices for lighting objects with indirect light cast by the background in 3-D virtual environments are presented. A ‘world view’ of a 3-D environment can be formatted as a panoramic, 360-degree image, such as cube map. For each object in the 3-D environment, the world-view cube map is transformed both in position and format to latitude-longitude maps (“lat-long map”) of the 3-D view from the perspective/position of the particular object. Each object's lat-long map is then blurred with a cosine (diffuse) convolution. The resulting blurred lat-long map gives a good approximation of all indirect light hitting the objects from every direction. The resulting blurred lat-long maps are then reconverted and downsampled back to ‘blurred’ cube maps associated with their respective objects. The blurred cube maps are then used to render indirect light on their respective objects. Indirect light can include Fresnel, rough reflective, normal, and other indirect light.

Separate ground plane images, such as those depicting an entire ball field, can be used along with the cube maps to create the lat-long map. The ground plane image can be used to render the grass, dirt, and lines of ball fields, while the cube map can be used to render the bleachers, scoreboard, and sky.

While many of the examples herein show ball fields in the context of sports-genre video games, it should be understood that the algorithms, systems, and devices taught herein are applicable to other video games, movies, CAD programs, and other formats.

To assist in transforming from cube maps to lat-long maps (and back again), a matrix of transform vectors can be stored as a color image. For example, in a three-dimensional space represented by Euclidean coordinates (x, y, z), the x-vector transformation for a particular pixel can be represented by red, the y-vector can be represented by green, and the z-vector can be represented by blue.

Some embodiments are directed to a method of lighting an object in a virtual environment with indirect light. The method includes receiving a cube map of a virtual environment, the cube map depicting the virtual environment from a central location, receiving a position of an object in the virtual environment, the object position being different than the central location, and translating, using at least one processor operatively coupled with a memory, the cube map depicting the virtual environment from a central location to a latitude-longitude map depicting the virtual environment from the object position, the latitude-longitude map associated with the object. The method further includes blurring the latitude-longitude map using a cosine diffuse convolution to create a blurred latitude-longitude map, converting the blurred latitude-longitude map to a blurred cube map, the blurred cube map associated with the object, and rendering indirect lighting of the object based on the blurred cube map.

Some embodiments are directed to a method of indirect lighting an object in a virtual environment. The method includes receiving a cube map of a virtual environment, receiving a position of an object in the virtual environment, generating, using at least one processor operatively coupled with a memory, a latitude-longitude map from a perspective of the object position based on the cube map and the object position, convolving the latitude-longitude map to create a blurred latitude-longitude map, and rendering indirect lighting of the object based on the blurred latitude-longitude map.

The method can further include converting the blurred latitude-longitude map to a blurred cube map, wherein the rendering uses the blurred cube map. Alternatively or in addition to using a blurred cube map, some embodiments can use a spherical harmonic method (SHM) in order to render the indirect light.

Other embodiments relate to machine-readable tangible storage media and computer systems that employ or store instructions for the methods described above.

A further understanding of the nature and the advantages of the embodiments disclosed and suggested herein may be realized by reference to the remaining portions of the specification and the attached drawings.

### BRIEF DESCRIPTION OF THE DRAWINGS

FIG. 1 illustrates a prior art method of indirect lighting an object.

FIG. 2 illustrates a world-view cube map of a virtual environment in accordance with an embodiment.

FIG. 3 illustrates a world-view ground plane image of a virtual environment in accordance with an embodiment.

FIG. 4 illustrates a position of a player in a ballpark in accordance with an embodiment.

FIG. 5 illustrates determining an upward view from a player's position in accordance with an embodiment.

FIG. 6 illustrates determining an downward view from a player's position in accordance with an embodiment.

FIG. 7 illustrates a latitude-longitude map in accordance with an embodiment.

FIG. 8 illustrates a blurred latitude-longitude map in accordance with an embodiment.

FIG. 9 illustrates cube maps associated with players in accordance with an embodiment.

FIG. 10 illustrates looking up a color from a local cube map in accordance with an embodiment.

FIG. 11 is a 3-D rendering of continuous indirect light using a model's normal vectors in accordance with an embodiment.

FIG. 12 is a 3-D rendering of indirect gloss energy, using a Fresnel term, on the model of FIG. 11 in accordance with an embodiment.

FIG. 13 is a 3-D rendering, including indirect light and reflections, of the model of FIG. 11 in accordance with an embodiment.

FIG. 14 is a flowchart of a process in accordance with an embodiment.

FIG. 15 is a flowchart of a process in accordance with an embodiment.

FIG. 16 illustrates a computer system suitable for implementing an embodiment.

### DETAILED DESCRIPTION

In general, methods, systems, and devices are described for lighting objects with indirect light cast by the background in 3-D virtual environments. This can give the illusion of real-time reflections from an object's viewpoint of the environment without having to render the full environment from the object's position. Indirect lighting of 3-D objects in a 3-D environment is achieved through a process of converting a world-view cube map into a latitude-longitude map that is local to each object, blurring the local lat-long map, turning the blurred lat-long map into a local cube map, then using the local cube map to light the object.

A “cube map” is one way to represent the surrounding view of a location. Cube maps, sometimes referred to as a class of light probes, include maps that represent the surrounding view of a location as a six-sided cube, although cube maps with less than six sides, or with some sides blank, are also called cube maps. Manipulation of cube maps are often supported by fast, hardware-based algorithms in graphic processing units (GPUs) and thus are easily and quickly manipulatable. Cube mapping using cube maps can be faster than image manipulation using sphere mapping in mirror ball or angular maps. A cube map can sometimes be said to approximate a mirror ball or angular map.

A “ground plane image,” sometimes referred to as a “top down view,” includes images depicting the ground. In some situations, a cube map represents the sky and surroundings while a ground plane represents the ground. A ground plane image can be handy when a character spends most of its time near its surface.

A “latitude-longitude map,” or “lat-long map,” is a surrounding-view format that maps horizontal and vertical dimensions onto a rectangular image. Lat-long maps typically range in azimuth (i.e., longitude) from 0 to 360 degrees, −90 to +270 degrees, or −180 to +180 degrees. They typically range in elevation angle (i.e., latitude) from −90 to +90 degrees.

The term “locally variant” includes the notion that reflections (or indirect light) change based on an object's position in a world environment. For example, as a player avatar runs toward a scoreboard in the background, the scoreboard becomes bigger in view. The scoreboard casts its own hue on the side of the player facing it. Meanwhile, grass, dirt, and chalk lines on the ground cast their own color on the player's shoes, pants, etc.

“Indirect lighting” an object can include more than indirectly lighting an object. Indirect lighting can include adjusting the color (including grayscale) of an object fragment that is already lit with a light source. The color adjustment can imitate light that is cast from non-light sources.

While direct lighting of 3-D objects is commonplace, indirect lighting of 3-D objects is a relatively advanced technique. Many video games with 3-D environments omit indirect lighting effects because they often requires processing power beyond what is available. Indirect light, however, can mean the difference between a fake-looking world and a realistic-looking world. The human eye can unconsciously distinguish the two using such cues.

Many games employ pre-computed spherical harmonics matrices derived from pre-computed cube maps. Spherical harmonics matrices include one 16-element matrix (i.e., a 4×4 matrix) for each red, green, and blue color; thus, three matrices. Cube maps are pre-computed, and then spherical harmonics matrices are pre-computed from the cube maps. The spherical harmonics matrices are what are used in the game.

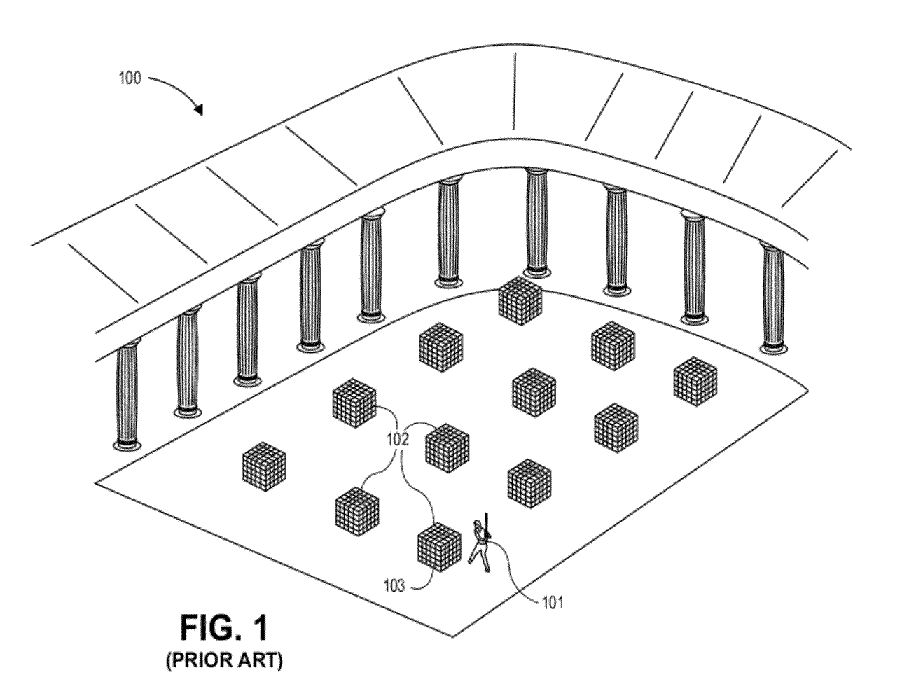

FIG. 1 illustrates a prior art method of lighting an object. In 3-D environment 100, avatar 101 walks, hits balls, and runs around a coliseum. When the avatar is in the middle of the coliseum, light from sky dominates over light reflected from the surrounding pillars. When the avatar is near a side of the coliseum, reflected light from the closest pillars should be apparent on the side of the avatar that faces the nearest pillars. Meanwhile, on the opposite side of the avatar's body, light from the sky should dominate even more because the pillars on the opposite side of the coliseum are even further away than they were when the avatar was in the center.

Cube maps and spherical harmonics matrices depicting the various lighting of the scene are pre-computed for predetermined areas in the 3-D environment. This occurs during development of the game, and the results are stored with the game graphics. Whatever cube map location that the avatar is closest to is used for indirect lighting of the avatar. In the figure, avatar 101 is closest to cube map location 103; thus, the spherical harmonics matrix associated with cube map 103 is used to render avatar 101. Obviously, this does not result in exactly realistic lighting of the avatar because avatar 101 is not in the same position as cube map 103. Although more cube maps and spherical harmonics matrices can be pre-computed to increase realism, this takes up memory and processor time in accessing the memory. Furthermore, on a field with bright lines or striking ground-to-grass interfaces, indirect light on the underside of a player can be very different from reality.

The pre-computed cube map/spherical harmonics matrices solution may be unworkable for environments that change. For example, a video game offering climates that change as an outdoor game progresses may not be able to pre-compute all the cube maps and spherical harmonics matrices in an environment before the start of gameplay. If clouds move in during gameplay, the light cast by the clouds may not be in the pre-computed cube maps.

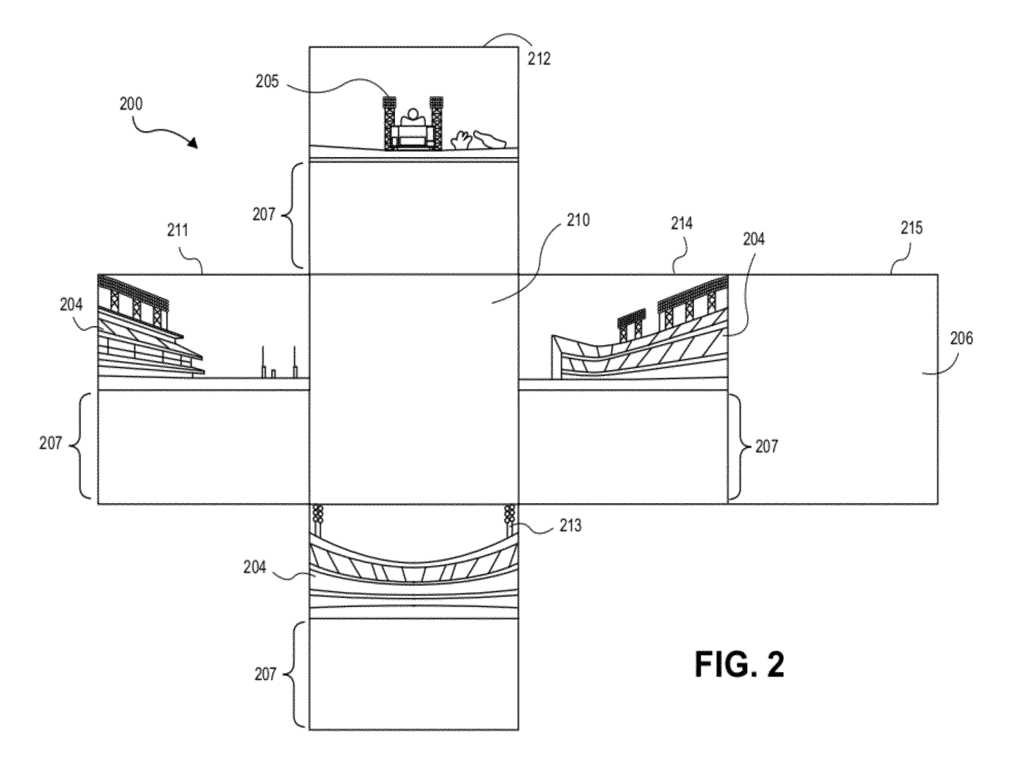

FIG. 2 illustrates a cube map of a virtual baseball ballpark in accordance with an embodiment. Cube map 200 has six squares, 210, 211, 212, 213, 214, 215, which depict the bottom, left, front, back, right, and top views from the center of the ballpark. In some squares, bleachers 204 can be seen wrapping around from the left to the back to the right. In other squares, the scoreboard and ballpark light structures 205 can be seen. Directly overhead, in square 215, open sky 206 is depicted. Sky 206 can have clouds, birds, advertising blimps, and other background objects. The cube map can be re-computed whenever the weather changes, clouds roll in, a blimp glides across the sky, or when a crowd performs ‘the wave.’ The cube map can be changed at the beginning of each inning or each play.

Approximately the lower half of left, front, back, and right squares 211, 212, 213, and 214, respectively, are blank. Also, bottom square 210 is blank. In the exemplary embodiment, the blank areas are those that are covered by a ground plane image.

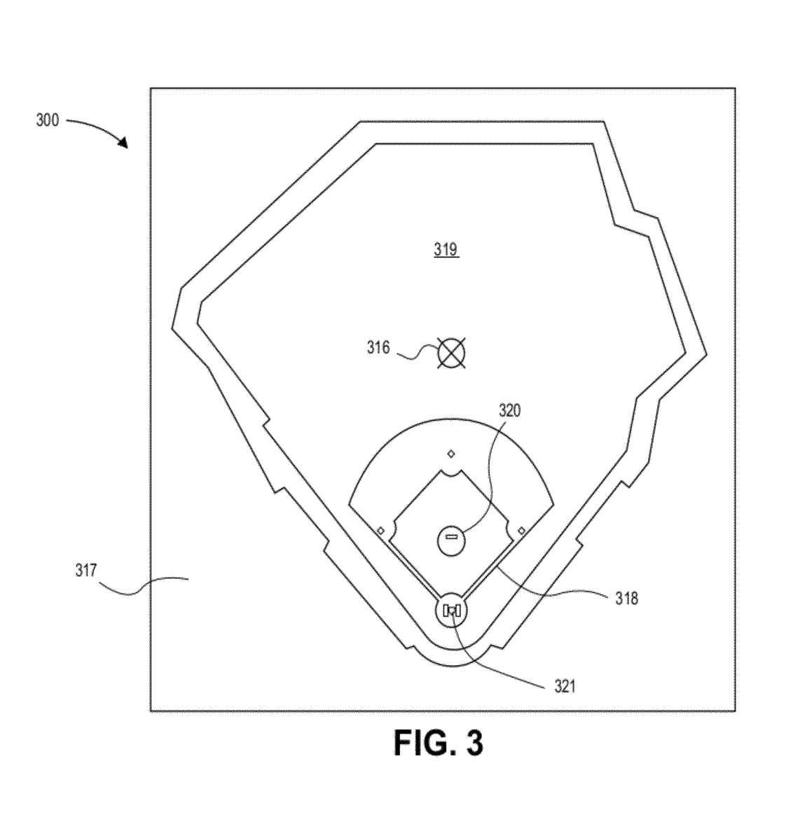

FIG. 3 illustrates a ground plane image of a virtual environment in accordance with an embodiment. Ground plane image 300 is surrounded by blank area 317. This area is covered by the cube map. Central location 316, which may or may not be in the center of the ballpark, is a convenient location to depict the surrounding ballpark with a panoramic view. Cube map 200 (FIG. 2) can be said to be the 360-degree panoramic view of the ballpark from central location 316.

Ground plane image 300 has baseball diamond 318 and outfield 319. Among other details, the baseball diamond includes pitcher's mound 320 and home plate 321.

Both the world-view cube map and ground plane image can be logarithmic encoded in order to preserve high dynamic range. For example, a color can be encoded in the following equation:

color_{encoded}=(log₁₀(color+0.101)+1)/3.0 (Eqn. 1)

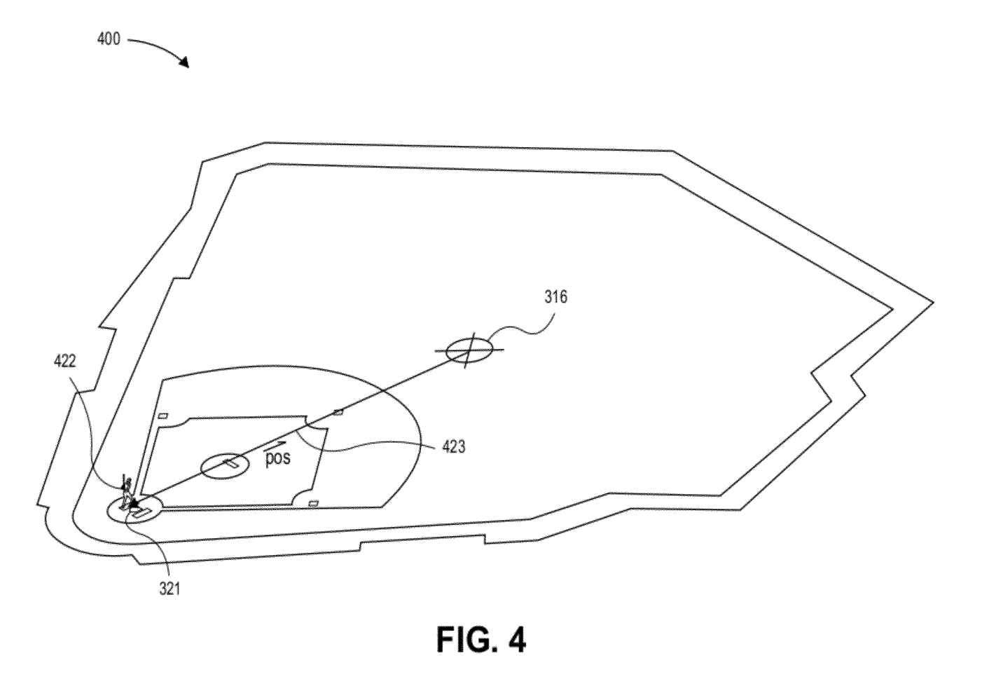

FIG. 4 illustrates a position of a player in a ballpark in accordance with an embodiment. Batter 422 stands behind home plate 321, which is well away from central location 316. The position of batter 422 is indicated by position vector 423 (“pos”). Position vector 423 indicates both the magnitude (i.e., distance) and direction of the player.

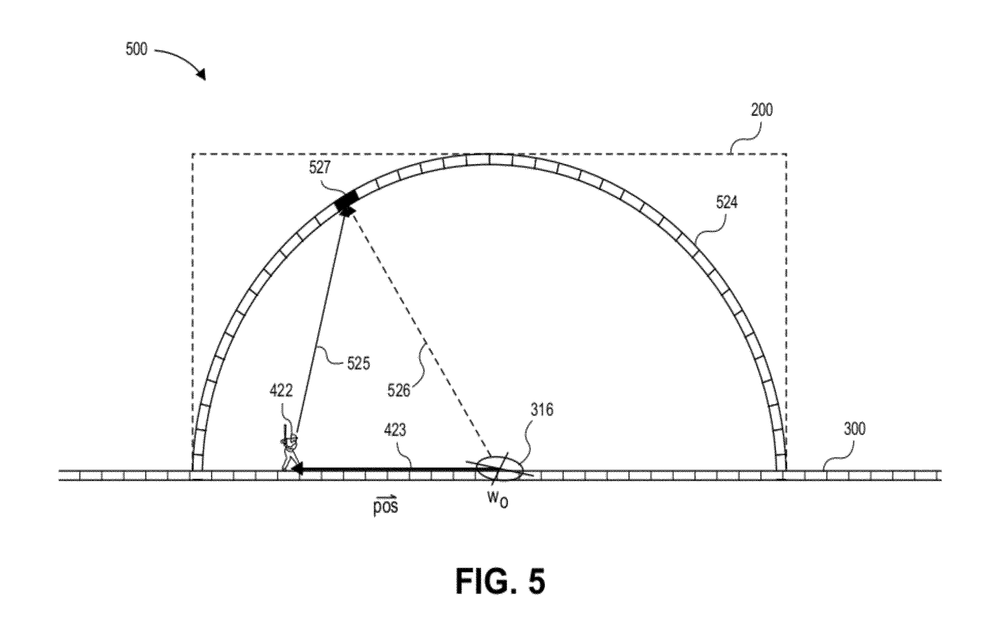

FIG. 5 illustrates determining an upward view from a player's position in accordance with an embodiment. Cube map 200 approximates spherical view 524. Spherical view 524 is drawn as a hemisphere in the figure to better illustrate the following vector geometry.

Batter 422 stands at position 423 (with respect to central location/origin 316). A piece of sky's color 527 from batter's position 422 is the same as the same piece of sky's color 527 from central location 316; however, the vector directions are different. By using vector algebra or other methods, one can determine the direction of vector 526 from vector 525 and position vector 423. Thus, the direction of vector 525 is mapped to the direction of vector 526. In other words, when one looks in the direction of vector 525 from the batter's position, it is equivalent to looking in the direction of vector 526 at the central location/origin of the world-view cube map. The direction vectors corresponding to vectors 525 and 526 can simply be unit vectors.

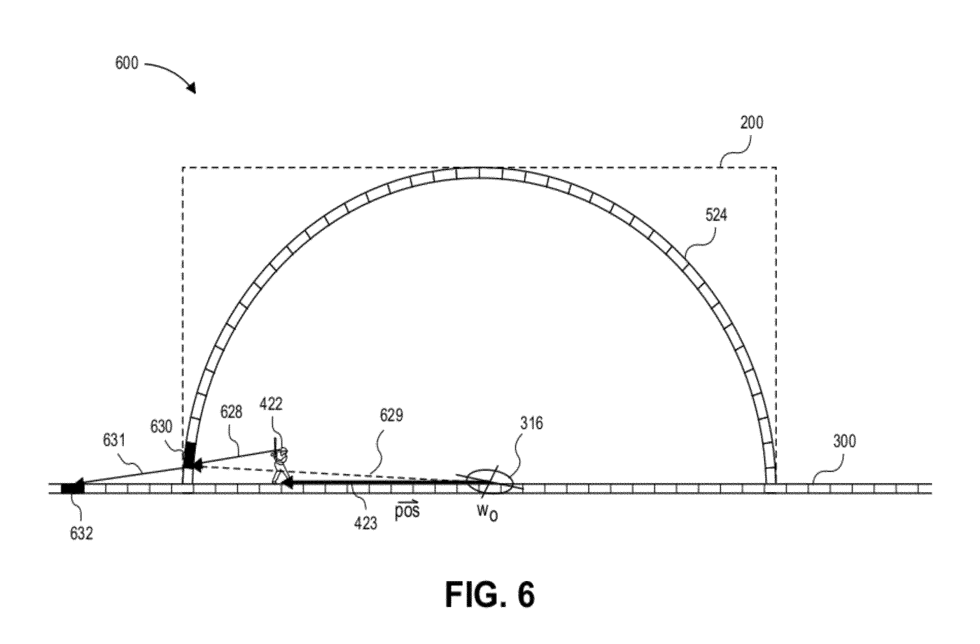

FIG. 6 illustrates determining an downward view from a player's position in accordance with an embodiment. In this scenario, there are two potential colors to select for mapping: one from the cube map and one from the ground plane.

A piece of the stadium's color 630 from batter's position 422 is the same as the same piece of stadium's color 630 from central location 316; however, the vector directions are different. One can determine the direction of vector 629 from vector 628 and position vector 423. Similar to the example in FIG. 5, the direction of vector 628 is mapped to the direction of vector 629. The ground plane image offers a different color.

A piece of ground color 632 from batter's position 422 is easily looked up from ground plane image 300 and direction vector 631. To determine which color to use in the exemplary embodiment, the closest point to the player is used. Thus, color 630 is used instead of color 632. Other embodiments use an average or other mix of the colors.

Using the above methods, the 360-degree panoramic view from the batter's position could be mapped to a local cube map at the player's position. Indeed, this may be done for reflections, etc. However, indirect light is naturally blurry, and cube maps have discontinuities that can cause problems with blurring algorithms. For example, if one were to simply blur each side of a cube map individually, then a dark feature near a first side of the cube would not contribute to blurring in an adjacent side of the cube. In the exemplary embodiment, the 360-degree panoramic view is mapped directly to a lat-long map.

To assist in transforming from cube maps to lat-long maps, a matrix of transform vectors is stored as a color image in red-green-blue (RGB) format. For example, in a three-dimensional space represented by Euclidean coordinates (x, y, z), the x-vector transformation for a particular pixel can be represented by red, the y-vector can be represented by green, and the z-vector can be represented by blue. Because graphics processor units handily manipulate and store images, this is a convenient way of storing the transform matrix.

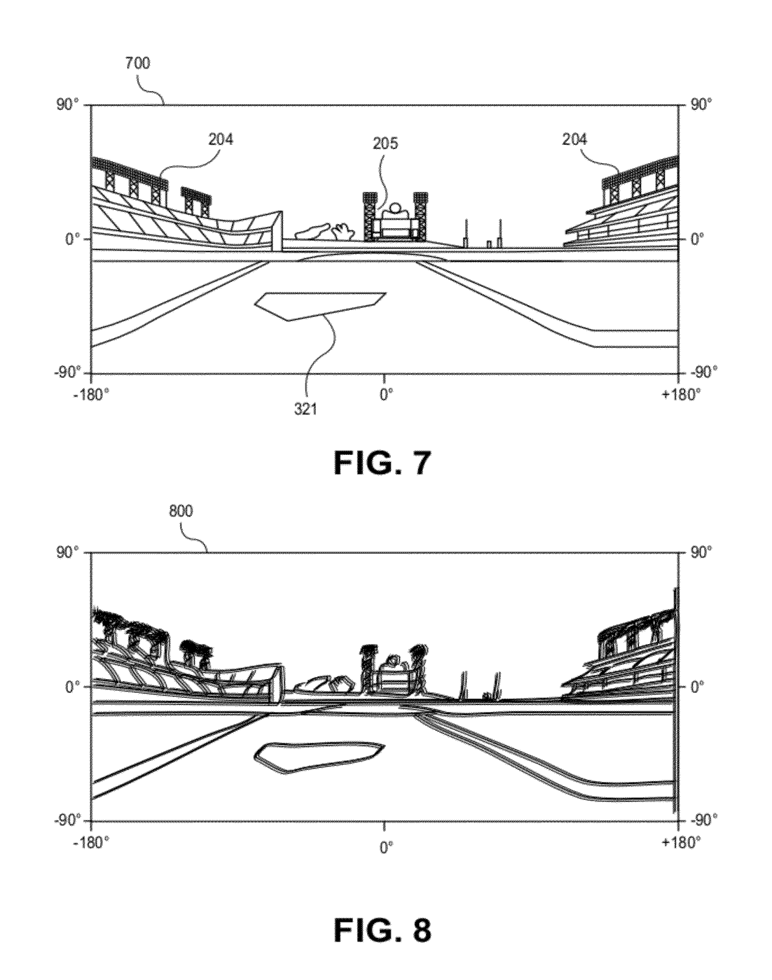

FIG. 7 illustrates a latitude-longitude map in accordance with an embodiment. Lat-long map 700 was generated by mapping vectors from world-view cube map 200 (FIG. 2) and ground plane image 300 (FIG. 3) using the above techniques for translating position within the world. The lat-long map shows a 360-degree azimuth view of the surroundings at the batter's position. Note that home plate 321 and light structures 205 of the stadium are visible just to the left of zero degrees azimuth, and that bleachers 204 wrap around the back behind the batter from −180 to +180 degrees.

A cosine (diffuse) convolution is applied through a cosine falloff blur shader to lat-long map 700 in order to blur it. For the blurring algorithms, the left and right edges are set to ‘wrap’ and the top and bottom edges are set to ‘mirror.’ The ‘mirror’ mode adequately approximates checking for out-of-range positions on the top or bottom (in the instantaneous blanket area of each convolution) and adding a 180-degree offset to those positions off to the left or right with wrap. The lat-long map can be overwritten itself, or a new lat-long map can be written.

FIG. 8 illustrates a blurred latitude-longitude map in accordance with an embodiment. Lat-long map 800 is the blurred version of lat-long map 700 from FIG. 7. Features are washed out, much like they are in real indirect lighting situations. Lat-long map 800 gives a good approximation of all indirect lighting hitting the character from every direction. Lat-long map 800 is sampled into a downsampled, blurred cube map, which only has eight-by-eight pixels on each side.

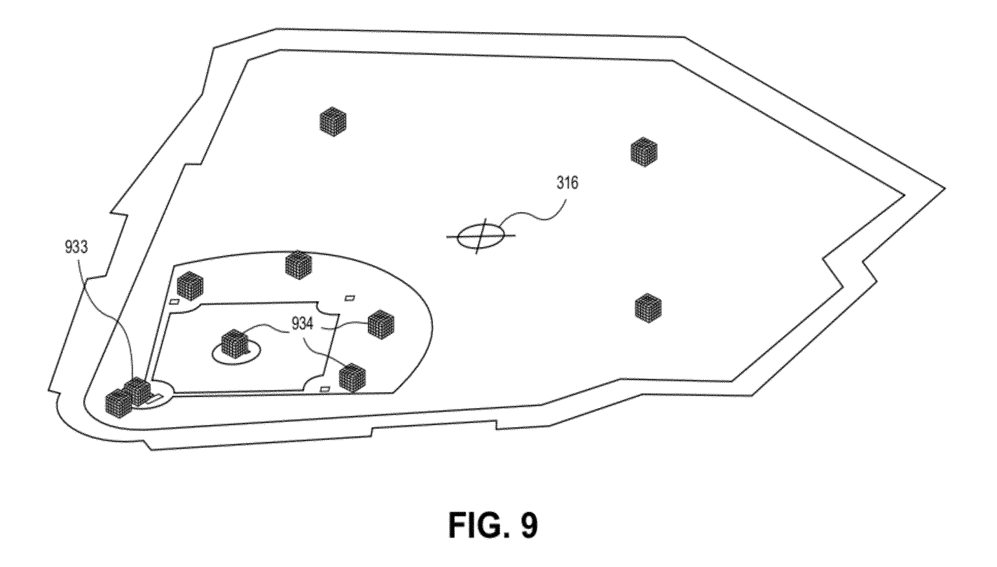

FIG. 9 illustrates cube maps associated with players in accordance with an embodiment. Cube map 933, the downsampled cube map created from lat-long map 800 (FIG. 8), is shown at the batter's position. This is for illustration purposes only; no cube is rendered at that position. The batter's cube map indicates all the indirect colors hitting the batter from the sky, surrounding stadium, and ground.

Other players' cube maps 934 are shown in their respective positions for illustration purposes. In an embodiment, blurred cube maps are generated for each player on the field. In some instances, individual blurred cube maps can be generated for various parts of the player, such as the player's face, shirt, and helmet. Depending upon the application, some of the cube maps can have less pixels per side than others. For example, the batter's shiny plastic shin guard may employ a cube map with many pixels per side because it is highly specular while the batter's uniform may employ a cube map with relatively few pixels because it is relatively rough and non-specular (i.e., diffuse). For realistic-looking reflections, a fragment to be colored can sample the original cube map or ground plane.

The blurred cube map local to each player can be used as long as the player is within a few inches of the position from which the blurred cube map was calculated. If a player moves more than a few inches, such as by running to catch a ball, then a new cube map can be computed for the player. In some embodiments, cube maps are generated for each frame until the player comes back to a rest state, such as that defined by moving around only within a half-foot radius. Cube maps can be saved at certain positions. For example, a cube map at the batter's position may be saved so that it can be used again and again for each successive batter. However, in some embodiments cube maps associated with the batter may be recomputed every few frames in order to correctly render indirect light for his walkup.

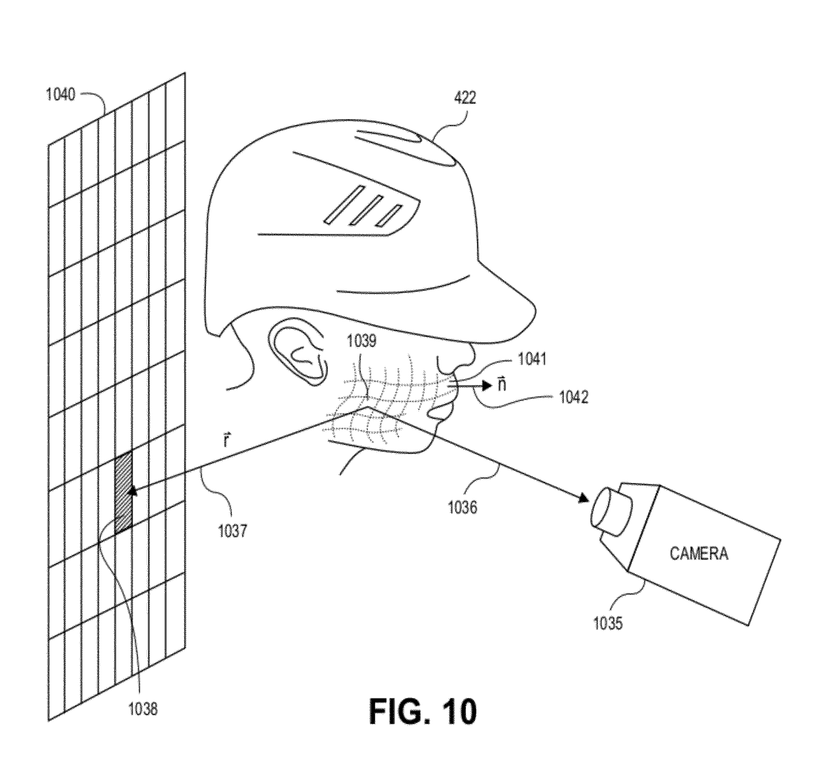

FIG. 10 illustrates looking up a color from a local cube map in accordance with an embodiment. Given a viewpoint of virtual camera 1035, the reflective, indirect gloss energy/color of fragment 1039 of batter 422's face is determined by determining reflective vector 1037 that has an opposite and equal angle from camera-to-fragment vector 1036. Reflective vector 1037 is used to look up color 1038 from local cube map 1040. Color 1038, multiplied by a Fresnel term, gives an element of the proper indirect lighting color of the player.

Similarly, normal vector 1042, which projects perpendicularly from fragment 1041 of batter 422's face, is used to look up another color from the local cube map. The mix of the normal and gloss energy colors, along with the color of batter's skin, various light sources, etc., are used to render the batter's face.

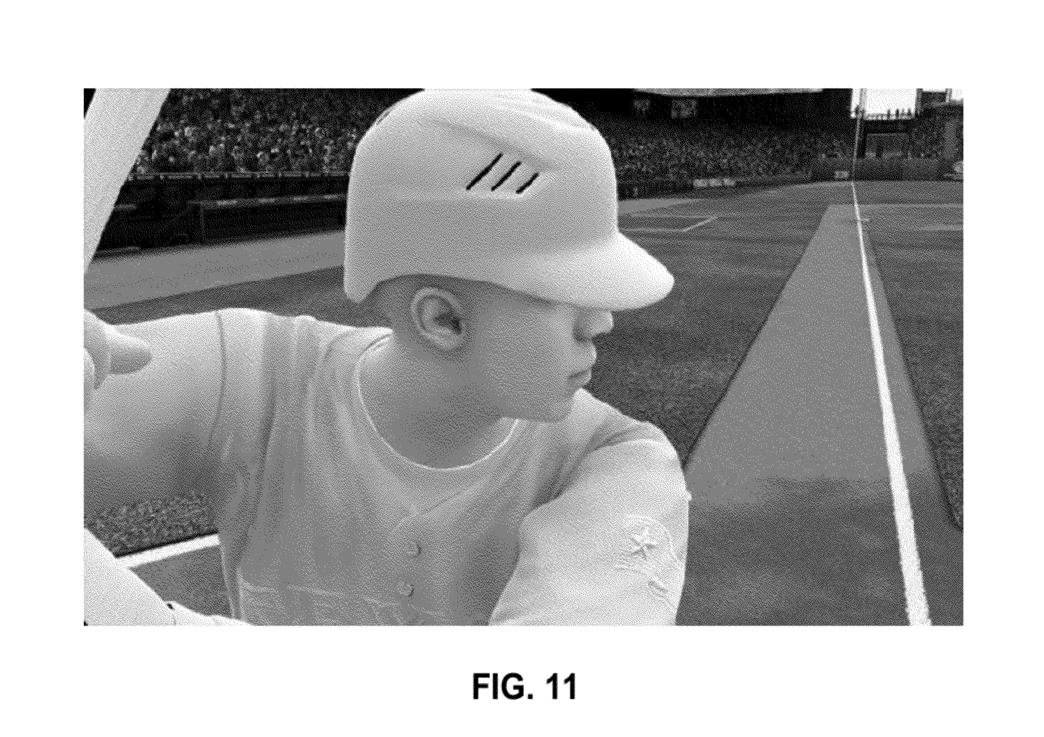

FIG. 11 is a 3-D rendering of continuous indirect light using a model's normal vectors in accordance with an embodiment. Normal vectors, such as normal vector 1042 (FIG. 10), are used to look up colors from the various directions. The figure shows only colors (in grayscale) associated with the normal vectors.

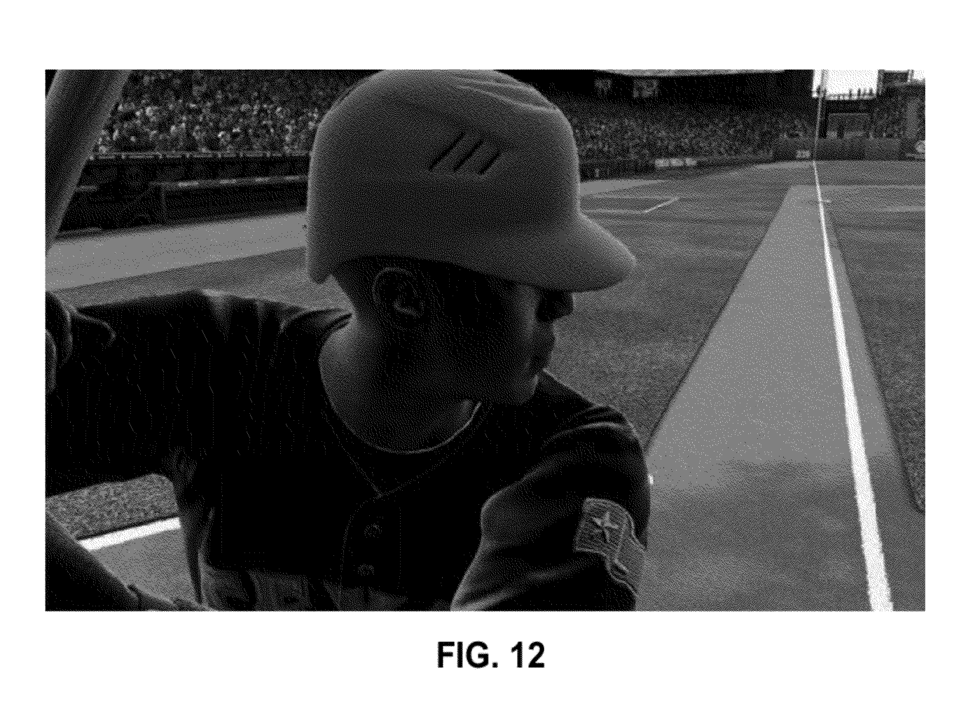

FIG. 12 is a 3-D rendering of indirect gloss energy, using a Fresnel term, on the model of FIG. 11 in accordance with an embodiment. Reflective vectors, such as reflective vector 1037 (FIG. 10), are used to render the batter. The figure shows only colors (in grayscale) associated with the reflective vectors. Note that there is more reflective light around the edges of the model where grazing reflections are more pronounced.

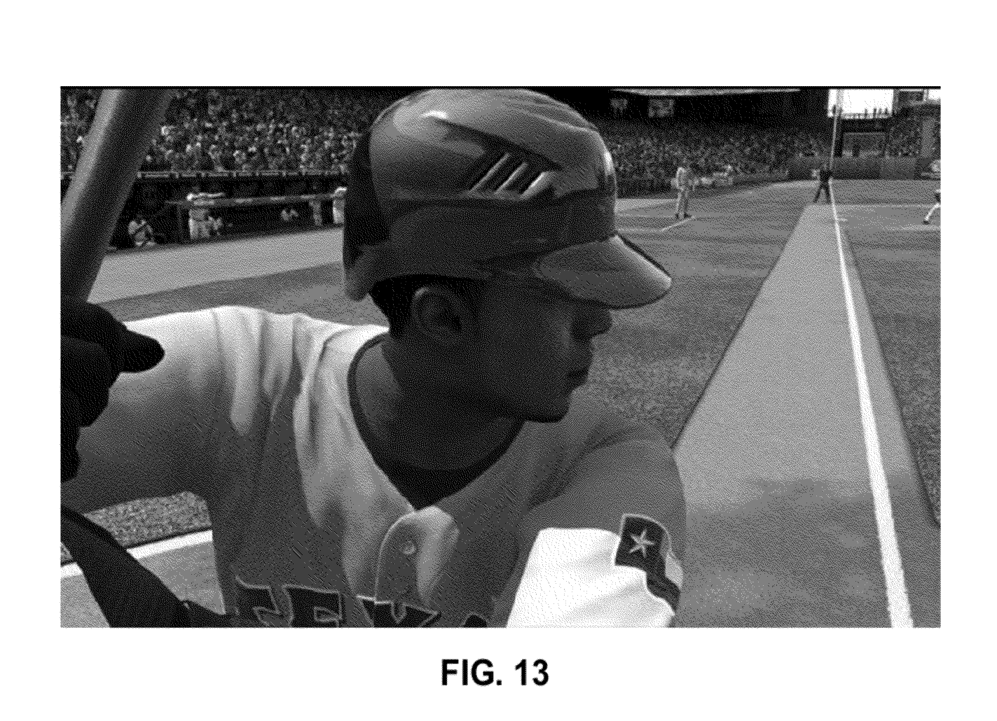

FIG. 13 is a final 3-D rendering, including indirect light and reflections, of the model of FIG. 11 in accordance with an embodiment. If one looks carefully, one can see the reflection of the first base line near the front of the batter's helmet.

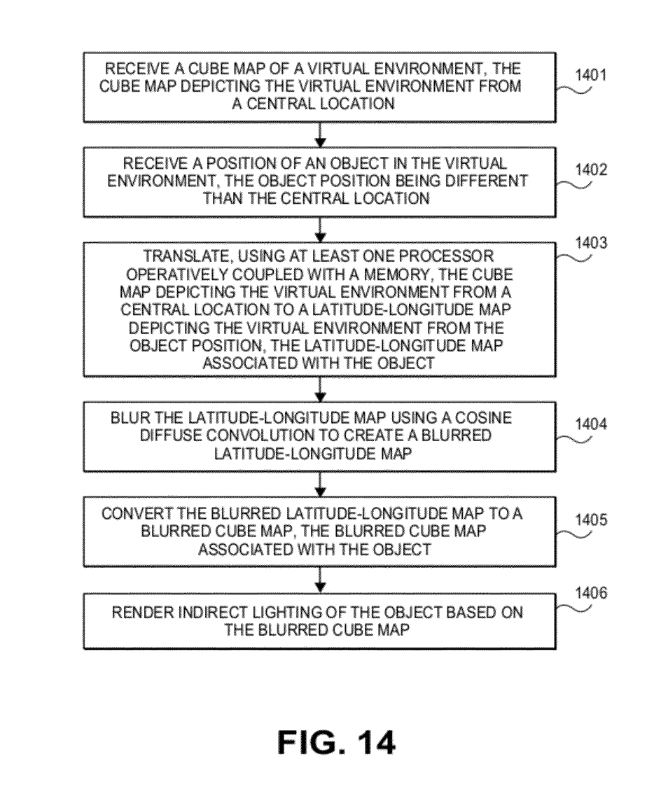

FIG. 14 is a flowchart illustrating process 1400 in accordance with one embodiment. In operation 1401, a cube map of a virtual environment is received, the cube map depicting the virtual environment from a central location. In operation 1402, a position of an object in the virtual environment is received, the object position being different than the central location. In operation 1403, the cube map depicting the virtual environment from a central location is translated, using at least one processor operatively coupled with a memory, to a latitude-longitude map depicting the virtual environment from the object position, the latitude-longitude map associated with the object. In operation 1404, the latitude-longitude map is blurred using a cosine diffuse convolution to create a blurred latitude-longitude map. In operation 1405, the blurred latitude-longitude map is converted to a blurred cube map, the blurred cube map associated with the object. In operation 1406, indirect lighting of the object is rendered based on the blurred cube map.

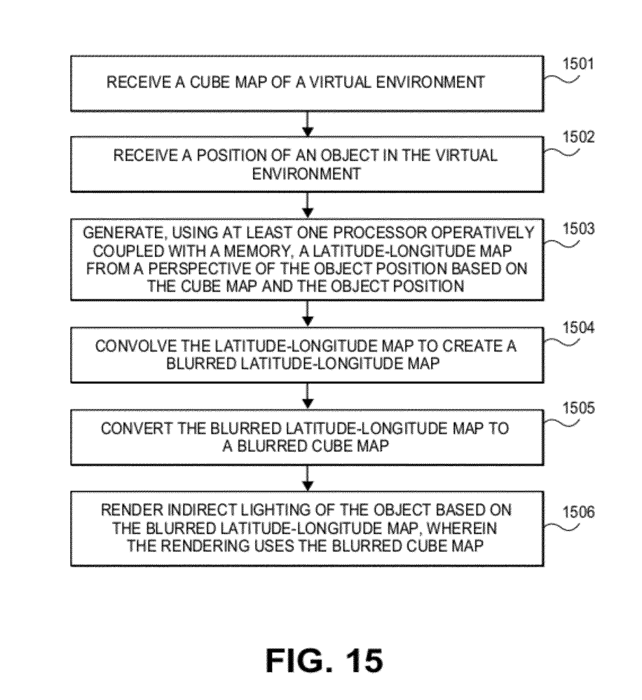

FIG. 15 is a flowchart illustrating process 1500 in accordance with an embodiment. In operation 1501, a cube map of a virtual environment is received. In operation 1502, a position of an object in the virtual environment is received. In operation 1503, a latitude-longitude map is generated, using at least one processor operatively coupled with a memory, from a perspective of the object position based on the cube map and the object position. In operation 1504, the latitude-longitude map is convolved to create a blurred latitude-longitude map. In operation 1505, the blurred latitude-longitude map is converted to a blurred cube map. The convolution and/or conversion can overwrite the existing latitude-longitude map or create a new map in other memory. In operation 1506, indirect lighting of the object is rendered based on the blurred latitude-longitude map, wherein the rendering uses the blurred cube map.

The operations may be performed in the sequence given above or in different orders as applicable. They can be automated in a computer or other machine and can be coded in software, firmware, or hard coded as machine-readable instructions and run through one or more processors that can implement the instructions.

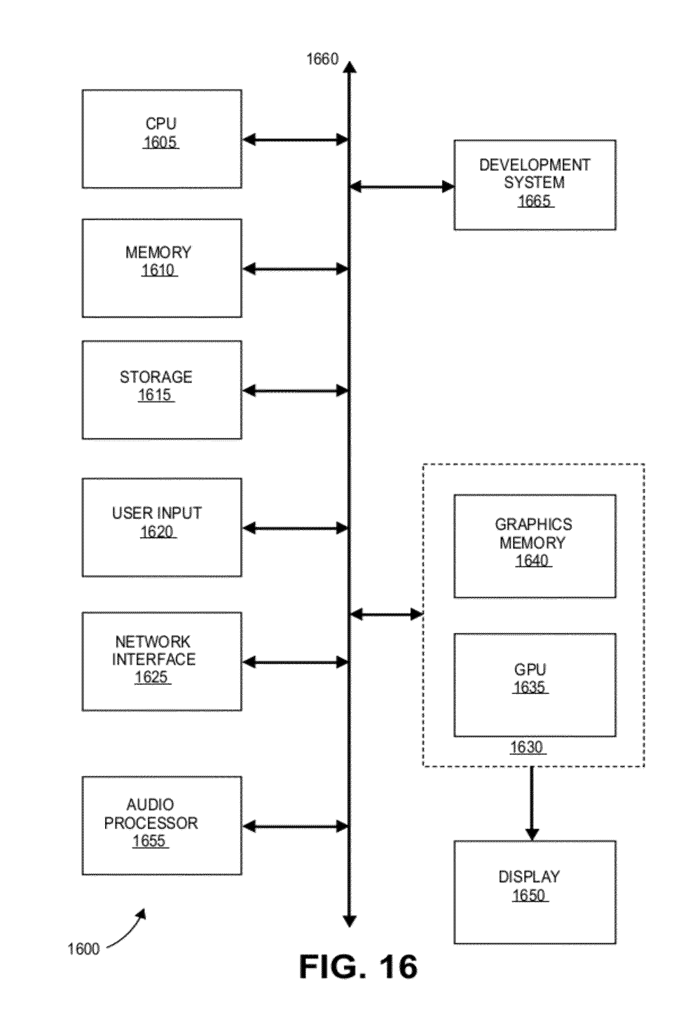

FIG. 16 illustrates an example of a hardware system suitable for implementing a device in accordance with various embodiments. This block diagram illustrates a computer system 1600, such as a personal computer, video game console and associated display, mobile device, personal digital assistant, or other digital device, suitable for practicing embodiments of the invention. Computer system 1600 includes a central processing unit (CPU) 1605 for running software applications and optionally an operating system. CPU 1605 may be made up of one or more homogeneous or heterogeneous processing cores. Memory 1610 stores applications and data for use by the CPU 1605. Storage 1615 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 1620 communicate user inputs from one or more users to the computer system 1600, examples of which may include keyboards, mice, joysticks, touch pads, touch screens, still or video cameras, and/or microphones. Network interface 1625 allows computer system 1600 to communicate with other computer systems via an electronic communications network, and may include wired or wireless communication over local area networks and wide area networks such as the Internet.

An audio processor 1630 is adapted to generate analog or digital audio output from instructions and/or data provided by the CPU 1605, memory 1610, and/or storage 1615. The components of computer system 1600, including CPU 1605, memory 1610, data storage 1615, user input devices 1620, network interface 1625, and audio processor 1630 are connected via one or more data buses 1635.

A graphics subsystem 1640 is further connected with data bus 1635 and the components of the computer system 1600. The graphics subsystem 1640 includes a graphics processing unit (GPU) 1645 and graphics memory 1650. Graphics memory 1650 includes a display memory (e.g., a frame buffer) used for storing pixel data for each pixel of an output image. Graphics memory 1650 can be integrated in the same device as GPU 1645, connected as a separate device with GPU 1645, and/or implemented within memory 1610. Pixel data can be provided to graphics memory 1650 directly from the CPU 1605. Alternatively, CPU 1605 provides the GPU 1645 with data and/or instructions defining the desired output images, from which the GPU 1645 generates the pixel data of one or more output images. The data and/or instructions defining the desired output images can be stored in memory 1610 and/or graphics memory 1650. In an embodiment, the GPU 1645 includes 3D rendering capabilities for generating pixel data for output images from instructions and data defining the geometry, lighting, shading, texturing, motion, and/or camera parameters for a scene. The GPU 1645 can further include one or more programmable execution units capable of executing shader programs.

The graphics subsystem 1640 periodically outputs pixel data for an image from graphics memory 1650 to be displayed on display device 1655. Display device 1655 can be any device capable of displaying visual information in response to a signal from the computer system 1600, including CRT, LCD, plasma, and OLED displays. Computer system 1600 can provide the display device 1655 with an analog or digital signal.

In accordance with various embodiments, CPU 1605 is one or more general-purpose microprocessors having one or more processing cores. Further embodiments can be implemented using one or more CPUs 1605 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network

(“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of lighting an object in a virtual environment with indirect light, the method comprising:
receiving a cube map of a virtual environment, the cube map depicting the virtual environment from a central location;
receiving a position of an object in the virtual environment, the object position being different than the central location;
translating, using at least one processor operatively coupled with a memory, the cube map depicting the virtual environment from a central location to a latitude-longitude map depicting the virtual environment from the object position, the latitude-longitude map associated with the object;
blurring the latitude-longitude map using a cosine diffuse convolution to create a blurred latitude-longitude map;
converting the blurred latitude-longitude map to a blurred cube map, the blurred cube map associated with the object; and
rendering indirect lighting of the object based on the blurred cube map.

2. A method of indirect lighting an object in a virtual environment, the method comprising:
receiving a cube map of a virtual environment;
receiving a position of an object in the virtual environment;
generating, using at least one processor operatively coupled with a memory, a latitude-longitude map from a perspective of the object position based on the cube map and the object position;
blurring the latitude-longitude map to create a blurred latitude-longitude map; and
rendering indirect lighting of the object based on the blurred latitude-longitude map.

3. The method of claim 2 further comprising:
converting the blurred latitude-longitude map to a blurred cube map,
wherein the rendering uses the blurred cube map.

4. The method of claim 3 further comprising:
determining a surface normal direction vector of a fragment of the object;
looking up a color from the blurred cube map using the surface normal direction vector; and
rendering the object fragment based on the looked-up color.

5. The method of claim 3 further comprising:
determining a reflection direction vector of a fragment of the object, the reflection vector based on a camera position with respect to the fragment;
looking up a color from the blurred cube map using the reflection direction vector; and
rendering the object fragment based on the looked-up color.

6. The method of claim 2 further comprising:
encoding a matrix of transform vectors as an image,
wherein generating the latitude-longitude map comprises using the image of encoded transform vectors to transform pixels in the cube map of the virtual environment to pixels in the latitude-longitude map.

7. The method of claim 2 further comprising:
receiving a ground plane image of the virtual environment,
wherein generating the latitude-longitude map is based on the ground plane image.

8. The method of claim 7 further comprising:
encoding the cube map of the virtual environment and the ground plane image with a logarithmic encoding,
thereby preserving high dynamic range.

9. The method of claim 2 wherein the blurring includes applying a cosine diffuse convolution.

10. The method of claim 9 wherein the cosine diffuse convolution is applied in a vertical pass and a horizontal pass.

11. The method of claim 2 wherein the object is a player avatar.

12. The method of claim 2 wherein the virtual environment comprises a sports playing field.

13. The method of claim 2 wherein rendering indirect lighting includes rendering normal and reflected Fresnel term adjusted light.

14. The method of claim 2 wherein the cube map approximates a mirror ball map.

15. The method of claim 2 wherein the operations are performed in the order shown.

16. The method of claim 2 wherein each operation is performed by the at least one processor operatively coupled to the memory.

17. A machine-readable tangible storage medium embodying information indicative of instructions for causing one or more machines to perform the operations of claim 2.

18. A computer system executing instructions in a computer program, the computer program instructions comprising program code for performing the operations of claim 2.

19. A machine-readable tangible medium embodying information indicative of instructions for causing one or more machines to perform operations comprising:
receiving a cube map of a virtual environment;
receiving a position of an object in the virtual environment;
generating a latitude-longitude map from a perspective of the object position based on the cube map and the object position;
blurring the latitude-longitude map to create a blurred latitude-longitude map; and
rendering indirect lighting of the object based on the blurred latitude-longitude map.

20. The medium of claim 19 further comprising instructions for:
converting the blurred latitude-longitude map to a blurred cube map,
wherein the rendering uses the blurred cube map
